(19) United States
(12) Patent Application Publication
(10) Pub. No.: US 2008/0208687 A1
(43) Pub. Date: Aug. 28, 2008

(54) SYSTEMS AND METHODS FOR PROVIDING CONSOLIDATED CARD DELIVERY FOR A PLURALITY OF ADVERTISERS

(76) Inventor: Garry S. McNeill, Seattle, WA (US)

Correspondence Address: Ruttler Law PLLC;One Union Square, 600 University Street, Suite 1919, Seattle, WA, 98101, US

(21) Appl. No.: 11/763,350

(22) Filed: Jun. 14, 2007

Related U.S. Application Data
(60) Provisional application No. 60/891,929, filed on Feb. 27, 2007.

(51) Int. Cl. G06Q 30/00

(52) U.S. Cl. 705/14

(57) ABSTRACT

This invention relates generally to advertising, and more specifically, to systems and methods for providing consolidated card delivery for a plurality of advertisers. In one embodiment, the method includes providing a website, the website being a software application accessible over a wide-area-network; accepting a first request through the website from a first advertiser to create a first card; accepting a second request through the website from a second advertiser to create a second card, the first and second advertisers each providing payment and demographic information; the first and second requests comprising card details, positioning selections, target distribution dates, and target consumers for the first and second cards; creating the first and second cards using a card manufacturer and a graphic designer to conform to the first and second requests; preparing a publication comprising the created first and second cards when the first and second requests include a similar target distribution date and target consumer, the created first and second cards being removably attached, the created first and second cards being positioned according to the positioning selections from the first and second requests; and distributing the publication to the target consumer via mail on the target distribution date, wherein the target consumer can use any of the first and second card for value with the first and second advertiser, respectively.

### PRIORITY CLAIM

This application claims the benefit of U.S. Provisional Application No. 60/891,929 filed Feb. 27, 2007. The foregoing application is incorporated by reference in its entirety as if fully set forth herein.

### FIELD OF THE INVENTION

This invention relates generally to advertising, and more specifically, to systems and methods for providing consolidated card delivery for a plurality of advertisers.

### BACKGROUND OF THE INVENTION

Advertising at its essence is a solicitation made by or on behalf of a company to a consumer for the purchase of a product or service. With the abundance and the creative means by which advertisements are positioned in our everyday lives, many people may assume that advertising is a modern phenomenon. Although many variations of and improved methodologies for advertising were indeed recently invented, the general idea of soliciting a product or service actually extends far back into history. Indeed, advertising can be traced to ancient civilizations such as Arabia, Greece, Rome, and Egypt where commercial and political displays were painted on rocks, walls or were even distributed on papyrus. After thousands of years, however, these rudimentary advertising means were improved upon almost overnight with the advent and exploitation of the printing press in the 15^{th} and 16^{th} centuries. Because the printing press permitted easy and efficient publication of periodicals and books, it similarly made it possible to mass produce printed advertisements within the publications or as standalone leaflets. The expanding economy coupled with the ease of printing extended print advertising to classified sections of newspapers, magazine pages, street cars, mail-order catalogs, and billboards and, in many ways, introduced the era of advertising that many would recognize as being prevalent today. However, even in the short period of time since, many refinements to advertising have been introduced with the dawn of radio, television, the internet, and mobile phones. With radio, advertisers began experimenting by sponsoring an entire program, but broadcasters quickly realized that more advertising revenue could be had by including multiple sponsors for the same program. The multiple sponsorship model then spilled over from radio into television in the 1960s and was improved upon with advertisements that appealed to consumers' emotions and visual tastes. Astoundingly, cable broadcasters soon found that they could charge consumers for shows and still sell advertising, which in some cases was the show that consumers paid to view such as QVC® and the Home Shopping Network®. The introduction and widespread use of the internet produced even more variations of advertising in the form of banner ads, fictitious buttons, animated ads, and countless others. Indeed many internet companies are financed by advertisers and are able to provide unrelated products or services for little or no charge. Some of the newest forms of advertising involve embedded content within television shows or movies, text messages, and interactive ads.

Despite the somewhat perplexing number of channels and variations of advertising within each of the channels, one relatively simple and older methodology is still successful: paper coupons. Paper coupons are typically found in newspapers or in magazines and offer a percentage or dollar amount discount off of a stated product or service. Thus, a bearer of the paper coupon can remove it from the newspaper or magazine and present it to a retailer to receive the discount. Although quite simple, paper coupons have attracted quite the following including some shoppers who collect paper coupons and organize entire shopping trips around the collection. One problem, however, with paper coupons is that they are over-exploited and consumers are inundated with paper coupon selections from various retailers and even for various products or services from a single retailer. One solution to this problem has been to organize paper coupons from a plurality of advertisers within a single publication or envelope and send the publication or envelope to a consumer, such as with the ValuePak®. The theory behind this extra effort is, presumably, to assist the consumer in organizing and sifting through printed coupons in a systematic fashion. However, because of the number of such publications has increased, their efficacy has been reduced and, frankly, their organized manner makes for easy disposal. Furthermore, advertising in such publications requires a tremendous amount of effort and resources.

Plastic card technology was introduced and became popular by facilitating banking transactions, such as those done in coordination with Visa® and MasterCard®. Their convenient size and ability to conveniently store vast amounts of information made plastic banking cards an instant hit among consumers. And, despite being fairly expensive to make, the expense was easily recouped after years of lucrative financial transactions. However, these same production expenses initially prevented many other fields where plastic card uses were more fleeting and less profitable from harnessing plastic card potential. Since the inception of plastic cards, though, card manufacturers have made significant strides to increase plastic card options and decrease production expenses. These improvements have been proportional to the increase in plastic card use in other fields, especially in retail where many outfits now have their own credit card, debit card, gift card, phone card, discount card, or purchase-tracking card. However, the number of plastic cards available from different retail shops and for different values within the retail shops has overwhelmed consumers. Further, although plastic cards have become more affordable, advertising using plastic cards still requires a tremendous amount of effort and resources.

In light of this background, there are a number of problems that have presented themselves and although desirable results have been achieved in the art, there is significant room for improvement. What is needed, therefore, are systems and methods for providing consolidated card delivery for a plurality of advertisers.

### SUMMARY OF THE INVENTION

This invention relates generally to advertising, and more specifically, to systems and methods for providing consolidated card delivery for a plurality of advertisers. In one embodiment, the method includes providing a website, the website being a software application accessible over a wide-area-network; accepting a first request through the website from a first advertiser to create a first card; accepting a second request through the website from a second advertiser to create a second card, the first and second advertisers each providing payment and demographic information; the first and second requests comprising card details, positioning selections, target distribution dates, and target consumers for the first and second cards; creating the first and second cards using a card manufacturer and a graphic designer to conform to the first and second requests; preparing a publication comprising the created first and second cards when the first and second requests include a similar target distribution date and target consumer, the created first and second cards being removably attached, the created first and second cards being positioned according to the positioning selections from the first and second requests; and distributing the publication to the target consumer via mail on the target distribution date, wherein the target consumer can use any of the first and second card for value with the first and second advertiser, respectively.

### BRIEF DESCRIPTION OF THE DRAWINGS

Embodiments of the present invention are described in detail below with reference to the following drawings:

FIG. 1 is a block diagram of a system for providing consolidated card delivery for a plurality of advertisers, in accordance with an embodiment of the invention;

FIG. 2 is a block diagram of a method for providing consolidated card delivery for a plurality of advertisers, in accordance with an embodiment of the invention;

FIG. 3 is a block diagram of a software application for facilitating card creation and consolidated card delivery for one or more advertisers, in accordance with an embodiment of the invention;

FIG. 4 is a block diagram of a portal for facilitating an exchange of cards between a plurality of consumers, in accordance with an embodiment of the invention;

FIG. 5 is top plan view of a consolidated card sheet, in accordance with an embodiment of the invention;

FIG. 6 includes side and front elevational views of a solar powered plant watering device, in accordance with an embodiment of an invention; and

FIG. 7 is a block diagram of a method for producing customized shoes for a consumer at a point of sale, in accordance with an embodiment of an invention.

### DETAILED DESCRIPTION

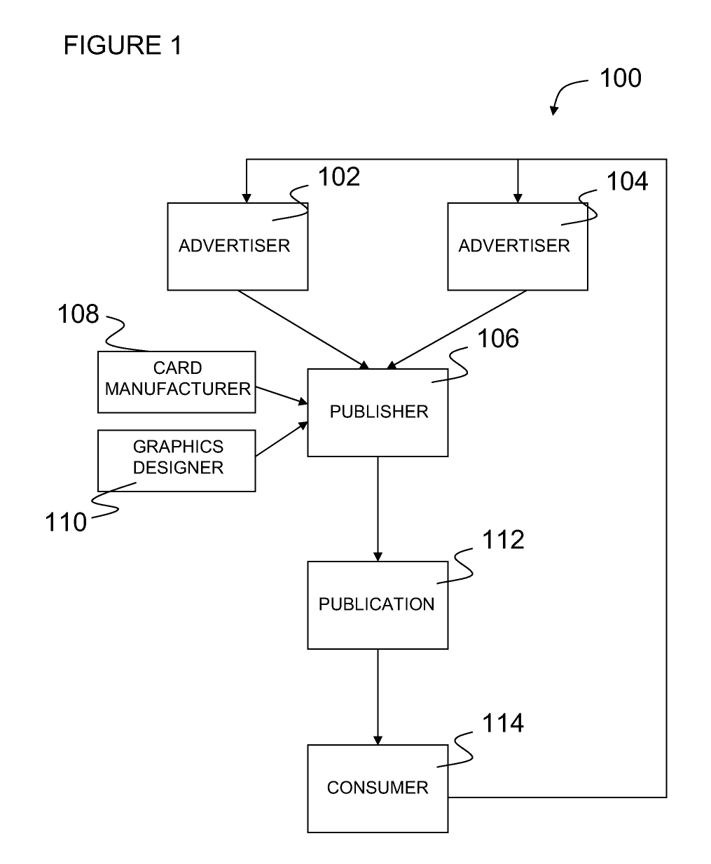

This invention relates generally to advertising, and more specifically, to systems and methods for providing consolidated card delivery for a plurality of advertisers. Specific details of certain embodiments of the invention are set forth in the following description and in FIGS. 1-7 to provide a thorough understanding of such embodiments. The present invention may have additional embodiments, may be practiced without one or more of the details described for any particular described embodiment, or may be practiced with any combination of details described for any particular embodiment.

FIG. 1 is a block diagram of a system for providing consolidated card delivery for a plurality of advertisers, in accordance with an embodiment of the invention. In one embodiment, system 100 includes an advertiser 102, an advertiser 104, a publisher 106, a card manufacturer 108, a graphics designer 110, a publication 112, and a consumer 114. The advertiser 102 and the advertiser 104 consult with the publisher 106 to create cards having value, a first and a second card respectively. The publisher 106 consults with the card manufacturer 108 and the graphics designer 110 to produce the first and second card on behalf of the advertiser 102 and the advertiser 104, respectively; although the advertiser 102 and the advertiser 104 can also consult with the card manufacturer 108 and the graphics designer 110. The publisher 106 then includes the created first and the second card within the publication 112 and distributes the publication 112 to the consumer 114. The consumer 114 can review the publication 112 and the first and second card contained therein and can optionally select either or both of the first and second cards. The consumer 114 can then make contact with the advertiser 102 or the advertiser 104 and use either the first or second card, respectively, to redeem its value. In one particular embodiment, the advertiser 102 and the advertiser 104 can rent, purchase, or otherwise use POS software and equipment from the publisher 106 to facilitate transactions using the first or second card.

In one embodiment, the advertiser 102 or the advertiser 104 are any individual, company, or entity with an interest in promoting sales of a product or service, including a donation. The advertiser 102 can be related or unrelated to the advertiser 104 and additional or fewer advertisers are certainly possible. For example, the advertiser 102 can be a clothing retail shop and the advertiser 104 can be a pizza parlor; alternatively, any of the advertisers can be banks, airlines, grocery stores, telephone companies, service organization or any other company, entity, or individual. Furthermore, the advertiser 102 or the advertiser 104 can be separated in degree from the publisher 106 by another entity, such as by an advertising agency that acts on behalf of various advertisers.

In one embodiment, the cards are plastic cards of any type, including PVC, styrene, PET, PETF, PETG, and laminate. Additional plastic types are possible and additional materials are possible, including paper, metal, wood, electronic, software based, or composite. The cards can include any technical features including plastic type, magnetic strips, RFID technology, smart chips, and bar codes. Further, the cards can include any design feature including thickness, size, foils, holograms, security inks, hot stamping, press polishes, UV coatings, matte finishes, UV cured inks, signature blocks, dye cuts, scratch off surfaces, liquid laminates, offset lithographic, and silkscreen. The cards can include any value including monetary value, percentage discount value, good or service value, lottery potential, purchase tracking, brand awareness, information, or any combination of actual or perceived values. In yet another embodiment, the card is non-physical and electronic or software.

In one embodiment, the publisher 106 is a separate entity from the card manufacturer 108 and the graphics designer 110. In other embodiments, the publisher 106 is the same entity as either or both of the card manufacturer 108 and the graphics designer 110. In still another embodiment, any of the publisher 106, the manufacturer 108, and the graphic designer 110 are omitted or augmented with other entities. In one particular embodiment, the advertiser 102 or the advertiser 104 can produce the card and/or card design and deliver such to the publisher 106 for inclusion in the publication. The publisher 106 can charge a fee for creating cards, designing cards, including cards in the publication, position or placement of the cards within the publication, consulting, or for another reason.

In one embodiment, the publication 112 includes the first and the second card removably attached using a perforation, using a fastener, or using some other means. Alternatively, the first and second card can be unattached. Additional or fewer cards can be included in the publication 112 for a given advertiser or for additional advertisers. The publication 112 can be mailed to the consumer 114, made available at a physical outlet for the consumer 114, or even delivered electronically to the consumer 114 such as in the case of software or electronic based cards or where information can be downloaded to a physical card.

In one embodiment, the consumer 114 can use any of the cards contained within the publication 112 to redeem value from the respective advertiser 102 or the advertiser 104. The consumer 114 optionally can add value to or re-use a card. Accordingly, a system is established for providing consolidated card delivery for a plurality of advertisers, whereby a consumer can use any of the cards to redeem value.

In various other embodiments, a single card can be employed for a plurality of advertisers and/or a plurality of values, such as a single card offering a percentage discount from an airline and a purchase tracker for discounts at a grocery store. In one particular embodiment the plurality of advertisers may be required to agree to such an arrangement. In additional embodiments, activity on a card at one advertiser can serve to trigger additional value on the card that can be redeemed at another advertiser, such as $100 dollars in grocery purchases that results in a discounted airline trip or a complimentary coffee from another advertiser redeemable using the same card. In one embodiment, cash can be added to the card or the card can be tied into banking systems for debit and credit transactions. In some embodiments, exchanges in values are tracked for tax purposes. In certain embodiments, the cards include technology to communicate with a remote server to track available and used values and ensure the proper values are present on the card.

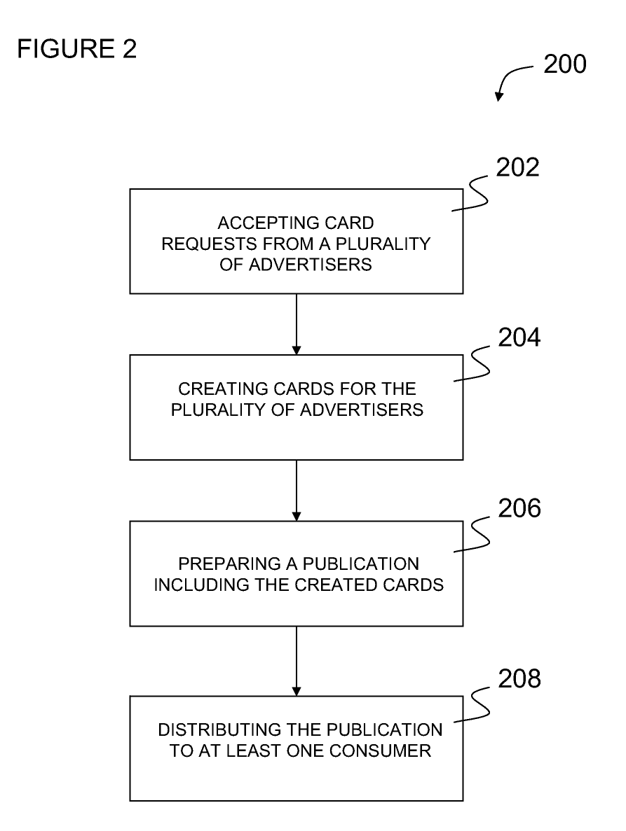

FIG. 2 is a block diagram of a method for providing consolidated card delivery for a plurality of advertisers, in accordance with an embodiment of the invention. In one embodiment, method 200 includes accepting card requests from a plurality of advertisers at block 202, creating cards for the plurality of advertisers at block 204, preparing a publication including the created cards at block 206, and distributing the publication to at least one consumer at block 208. Method 200 implements one or more embodiments discussed in reference to FIG. 1.

In one embodiment, the accepting card requests from a plurality of advertisers at block 202 includes accepting card details such as technical features, design features, value types, and value amounts and positioning selections, target distribution dates, and target consumers for cards from the plurality of advertisers. Technical features have been previously discussed and can include aspects like magnetic strips, bar codes, serial numbers, data encoding, smart card technology, and RFID technology. Design features have been previously discussed and can include aspects like visual print designs, card thickness, and card shape. Value types have been previously discussed and can include dollar discounts, percentage discounts, cash amounts, complimentary products or services, lottery potential, information, and the like. Value amounts are a discreet number of value types, such as a number of complimentary products (i.e. 5 products) and services (i.e. 5 hours) or a number of a percentage discount (i.e. 10%). Positioning selections can include a desired position within a publication (i.e. front, middle, or back). Target distribution dates can include a specific day, date, time frame, or combination of the same for distributing any cards. Target consumers can be any individual or group of individuals, which can be defined by a classification such as a zip codes, club membership, or professional affiliation. Indeed fewer or greater card variations and features are requestable by the plurality of advertisers. In one particular embodiment, the plurality of advertisers is limited to a single advertiser. Further, each of the plurality of advertisers can request one or more cards, each of which can have different technical features, design features, value types, value amounts, and positioning selections, target distribution dates, and target consumers. Further, a single card can be usable with a plurality of advertisers and/or can include a plurality of value types and values. For example, one advertiser can request a wallet sized PVC card having a magnetic strip and having a logo disposed thereon. The advertiser can further request that the magnetic strip be loaded with a 10% discount off grocery purchases of $50 or more for the next three months and that the face of the card indicate such. The advertiser can go further and request the same card in a key chain size. Another advertiser can request a wallet sized PET card having a magnetic strip loaded with a complimentary legal consultation within a month and that the face of the card indicate such. Alternatively, the accepting card requests step can be omitted in full or in part and cards or designs can be supplied by the plurality of advertisers.

The creating cards for the plurality of advertisers at block 204 includes preparing cards that meet the card requests from the plurality of advertisers. The creating can be accomplished by outsourcing one or more components of the card, such as physical card creation, data embedding, and graphic design or can be accomplished internally without outsourcing. The preparing a publication including the created cards at block 206 includes grouping the created cards for the plurality of advertisers having similar target distribution dates and target consumers and disposing the grouped cards into a mailing envelope while considering any positioning selections. In one particular embodiment the mailing envelope is software or electronically based rather than physical. Accordingly, the grouped cards can contain various cards for various advertisers each having various technical features, design features, values types, and value amounts. Thus, grouped cards within a mailing envelope can contain a grocery discount card as well as a complimentary legal consultation card. In certain embodiments, the grouped cards can include cards for advertisers offering related goods or services, such as clothing retailers, automotive shops, legal services, or grocery outlets.

The distributing the publication to at least one consumer at block 208 includes delivering the envelope to a consumer, whereby the consumer can view and select from the cards disposed therein and use the cards at a corresponding advertiser to redeem value. In one particular embodiment, the consumer can re-use a card or even add value to a card. Accordingly, a method is provided for receiving card requests from a plurality of advertisers, creating the cards to meet the requests, consolidating the cards into a publication, and distributing the publication to a consumer who can select from and use the cards with the corresponding advertisers.

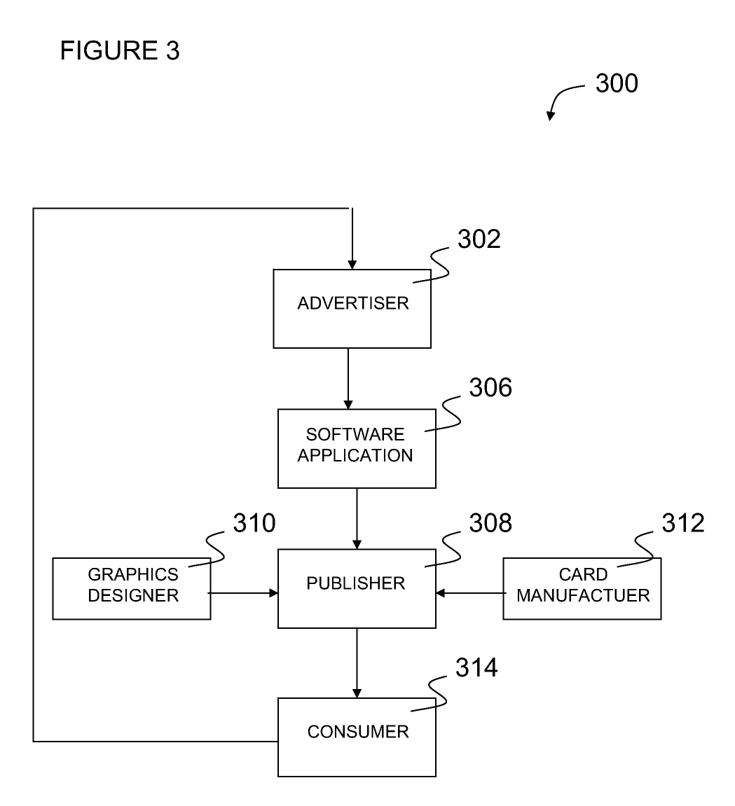

FIG. 3 is a block diagram of a software application for facilitating card creation and consolidated card delivery for one or more advertisers, in accordance with an embodiment of the invention. In one embodiment, system 300 includes an advertiser 302, a software application 306, a publisher 308, a graphics designer 310, a card manufacturer 312, and a consumer 314. The advertiser 302 accesses the software application 306, such as by using the internet, and uses the software application 306 to select from standard cards or to build a custom card for delivery to the consumer 314. To begin, the software application 306 accepts demographic and payment information from the advertiser 302; although this step can be alternatively sequenced. Next, the advertiser 302 reviews one or more standard cards or elects to build a custom card using the software application 306. Standard cards can be less expensive, more quickly produced, and involve fewer decisions for the advertiser 302; these cards can embody the most common technical features, design features, value types, and value amounts. For instance, a standard card can include a wallet sized PET card having a graphic of a flower and a magnetic strip loaded with 10% off purchases. The standard cards can permit some minor customization such as printing a name of the advertiser 302 on the card. Custom cards can be more expensive and more slowly produced, but can allow for greater variation and uniqueness for the advertiser 302. For custom cards, the software application 306 provides an intuitive and user-friendly interface for the advertiser 302 to view, select from, and preview various technical features, design features, value types, and value amounts. Thus, for custom cards the advertiser 302 can select a unique card shape, upload personalized graphics, and input specific value types and value amounts. For example, the advertiser 302 can be a clothing store and can select a wallet-sized t-shirt shaped PETG card having a logo from the advertiser 302 disposed thereon and a magnetic strip loaded with data providing a $10 cash value on purchases over $50. Once the advertiser 302 selects a standard card or builds a custom card, the advertiser 302 can select from options for target distribution dates (i.e. a month before Christmas); target consumers (i.e. new homeowners or a zip code); positioning selections (i.e. front or back); or other similar options; although this step can be alternatively sequenced. The advertiser 306 can then review and submit an order using the software application 306, the order including any of demographic information, payment information, a card selection, a target distribution date, a target consumer, and position information. Although not necessary, the software application 306 can include online assistance or the advertiser 306 can email or otherwise contact the publisher 308 for assistance. The publisher 308 then receives the order and establishes a card to meet the order such as by using the graphics designer 310 and the card manufacturer 312. The software application 306 can be similarly accessed by one or more additional advertisers who can similarly submit an order. The publisher 308 then includes the established card for the advertiser 302, and any other established cards for other advertisers, in a publication and distributes the publication to the consumer 314. The consumer can use, re-use, or re-charge the established card for value with the advertiser 302.

In one particular embodiment, the software application 306 can provide match-making services for a plurality of advertisers to share cards or offer cross-promotions. A first advertiser can indicate an interest in sharing a card with a second advertiser or an interest in offering cross-promotions with a second advertiser. The interest can be general in nature and targeted at any second advertiser for any card-sharing or cross-promotion arrangement or can be quite specific and targeted to a given second advertiser for a specific card-sharing or cross-promotion arrangement. The interest is published on the software application 306 for potential second advertisers to review and the software application 306 facilitates such arrangements between the second advertiser and the first advertiser. Upon agreement between the first and second advertiser, the software application 306 is used to establish the card, which is deliverable to the consumer 314. An example of a card-sharing or cross-promotion would be a book store and a coffee shop establishing a single card usable at both the book store and the coffee shop for discounts or the book store offering discounts on books for purchases made at the coffee shop and the coffee shop offering discounts on coffee for purchases made at the book store.

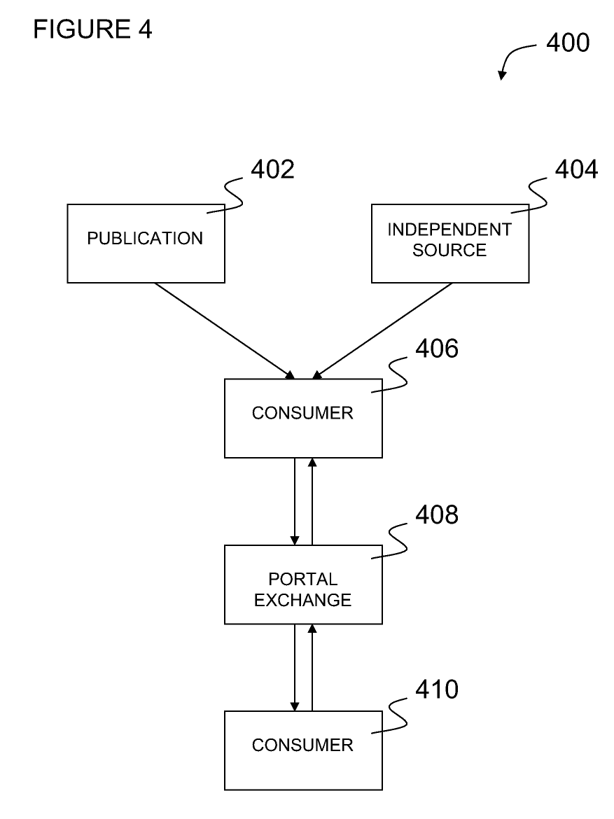

FIG. 4 is a block diagram of a portal for facilitating an exchange of cards between a plurality of consumers, in accordance with an embodiment of the invention. In one embodiment, system 400 includes a publication 402, an independent source 404, a consumer 406, a portal exchange 408, and a consumer 410. The publication 402 includes a plurality of cards from one or more advertisers, as discussed herein. The independent source 404 is any avenue for which cards can be obtained without the publication 402; possible avenues include direct from an advertiser or from a card distributor such as a grocery outlet. The consumer 406 can receive cards from the publication 402 or the independent source 404 and can use, re-use, or re-charge the cards at corresponding advertisers, as discussed herein. However, in some instances the consumer 406 may not have an interest in using a received card, perhaps because the consumer 406 does not need the products and services that a corresponding advertiser peddles or for some other reason. Instead of discarding the card, the consumer 406 can access the portal exchange 408 to exchange or sell the unwanted card. The portal exchange 408 can be a software application that is accessible using the internet. Another consumer, such as the consumer 410, who can be distant and unknown to the consumer 406, can similarly access the portal exchange 408 to purchase or exchange for the card from the consumer 406. The consumer 410 can then use the card obtained through the portal exchange 408 at the corresponding advertiser. Accordingly, a system is established for exchanging cards between consumers that are usable, re-usable, and re-chargeable at various advertisers.

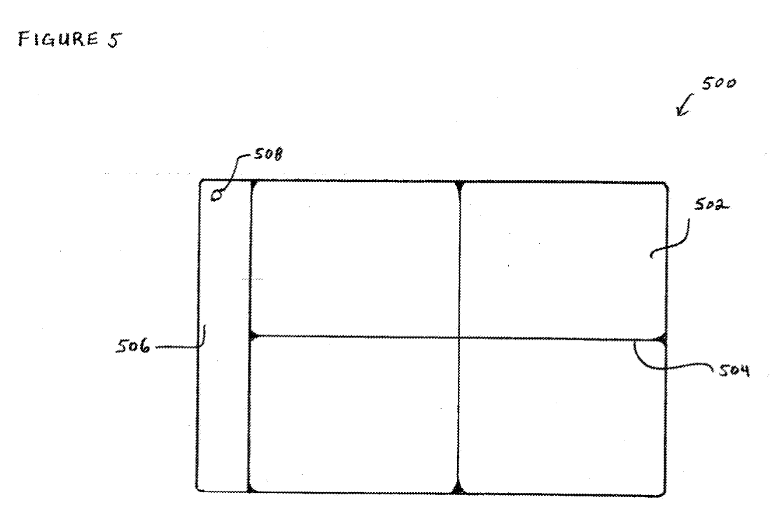

FIG. 5 is top plan view of a consolidated card sheet, in accordance with an embodiment of the invention. In one embodiment, consolidated card sheet 500 includes a plurality of cards 502, a perforation 504, a binding 506, and a ring 508. The plurality of cards 502 are removably coupled together and to the binding 506 using the perforation 504. Thus, any of the plurality of cards 502 can be detached by applying force against the perforation 504. The ring 508 is configurable to permit the binding 506 to couple to one or more additional bindings. The consolidated card sheet 500 can be included as a publication, as discussed herein. In one particular embodiment, each of the plurality of cards 502 include various technical features, design features, value types, and value amounts, which can be different between cards.

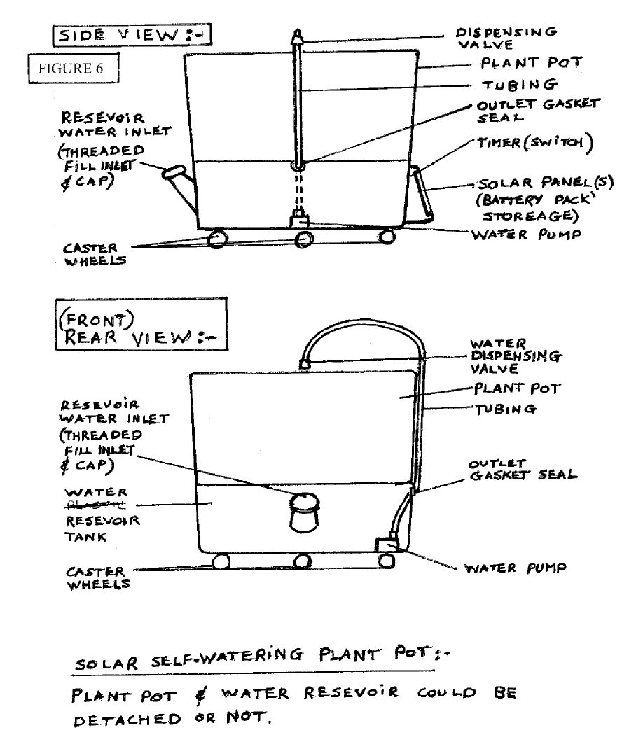

FIG. 6 includes side and front elevational views of a solar powered plant watering device, in accordance with an embodiment of an invention. In one embodiment, the solar powered plant watering device includes a reservoir configurable to receiving water through an inlet and storing the water for later use. A water pump is disposed within the reservoir and is configurable to pumping water from the reservoir through tubing. A plant pot can be disposed on or adjacent to the reservoir and the tubing, whereby water from the tubing is depositable within the plant pot and proximate to any plant disposed therein. The water pump can be powered by a wall outlet, a battery source, or solar power. In the case of the latter, solar cells for converting sunlight into electrical energy can be disposed on the exterior of the reservoir. Electrical energy from the solar cells can power or re-charge a battery, which then powers the water pump, or can directly power the water pump. A timer can further be implemented in association with the water pump to control time, duration, or amount of water pumped. Further, wheels can be disposed on the reservoir to provide mobility of the reservoir and any plant pot disposed thereon.

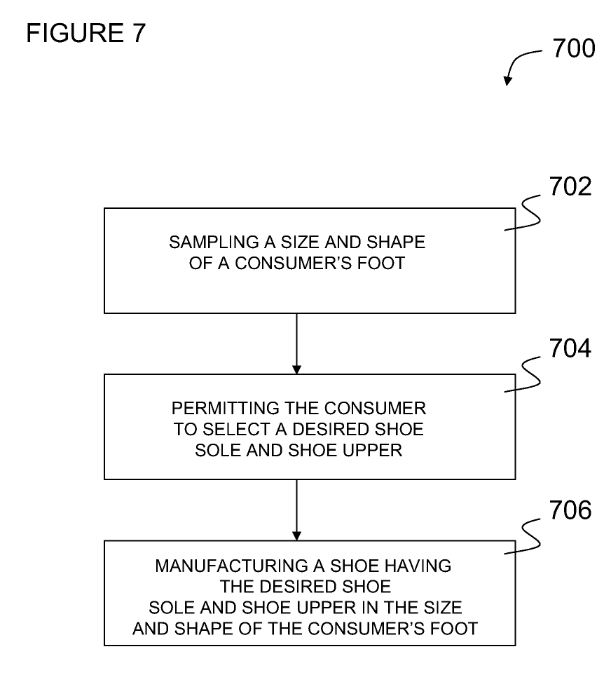

FIG. 7 is a block diagram of a method for producing customized shoes for a consumer at a point of sale, in accordance with an embodiment of an invention. In one embodiment, method 700 includes sampling a size and shape of a consumer's foot at block 702, permitting the consumer to select a desired shoe sole and shoe upper at block 704, and manufacturing a shoe having the desired shoe sole and shoe upper in the size and shape of the consumer's foot at block 706. Method 700 can be performed at a retail outlet thereby permitting customized shoes to be produced at a point of sale. The sampling a size and shape of a consumer's foot at block 702 includes using a 2D or 3D scanner, measuring device, mold, or other device to obtain data such as a length of the consumer's foot, a width of the consumer's foot, and a surface geometry description of the consumer's foot. The permitting the consumer to select a desired shoe sole and shoe upper at block 704 includes providing a plurality of sample shoe sole and shoe upper selections for the consumer to view and select from, such as various athletic shoe soles and shoe uppers and various dress shoe soles and shoe uppers. In addition, any of the shoe soles and shoe uppers can be in various color options. The manufacturing a shoe having the desired shoe sole and shoe upper in the size and shape of the consumer's foot at block 706 includes obtaining a shoe sole and shoe upper selected from block 704 that conform to the size and shape of the consumer's foot sampled at block 702 and coupling the shoe sole and shoe upper together. In one particular embodiment, the coupling is accomplished automatically by a machine or robot. In yet another embodiment, the manufacturing a shoe having the desired shoe sole and shoe upper in the size and shape of the consumer's foot at block 706 includes creating a selected shoe sole and/or shoe upper selected from block 704 from one or more raw materials using a CNC machine, robot, injection molding machine, or other manufacturing device and coupling the shoe sole and shoe upper together.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method for providing consolidated card delivery for a plurality of advertisers, the method comprising the steps of:
providing a website, the website being a software application accessible over a wide-area-network;
accepting a first request through the website from a first advertiser to create a first card;
accepting a second request through the website from a second advertiser to create a second card, the first and second advertisers each providing payment and demographic information; the first and second requests comprising card details, positioning selections, target distribution dates, and target consumers for the first and second cards;
creating the first and second cards using a card manufacturer and a graphic designer to conform to the first and second requests;
preparing a publication comprising the created first and second cards when the first and second requests include a similar target distribution date and target consumer, the created first and second cards being removably attached, the created first and second cards being positioned according to the positioning selections from the first and second requests; and
distributing the publication to the target consumer via mail on the target distribution date, wherein the target consumer can use any of the first and second card for value with the first and second advertiser, respectively.

2. The method of claim 1, wherein the card details comprise technical features, design features, value types, and value amounts.

3. The method of claim 1, wherein the target consumer can further re-use and re-charge the first and second card with the first and second advertiser, respectively.

4. A software application for facilitating card creation and delivery for an advertiser, the software application comprising:
a user-interface, the user-interface configurable to being accessible to an advertiser over a wide-area-network, the user-interface configurable to performing the steps of
presenting an option to the advertiser to choose a standard card, the standard card embodying common card details, the standard card permitting only minor customization;
presenting an option to the advertiser to build a custom card, the custom card permitting customized card details;
accepting a card selection from the advertiser for either the standard card option or the custom card option;
if the custom card option is selected, further accepting from the advertiser the customized card details;
accepting distribution selections from the advertiser, the distribution selections including a target distribution date and a target consumer;
accepting a positioning selection from the advertiser;
accepting payment information and demographic information from the advertiser;
displaying a summary of an order for the advertiser, the order comprising the card selection, the distribution selections, the positioning selection, the payment information, and the demographic information; and
accepting the order,
wherein a card is created using a card manufacturer and a graphic designer conforming to the order, wherein a publication is prepared including the created card at a position within the publication based on the positioning selection, wherein the publication is distributed to the target consumer on the target distribution date, and wherein the target consumer can use the created card for value with the advertiser.

5. The software application of claim 4, wherein the card details comprise technical features, design features, value types, and value amounts.

6. The software application of claim 4, wherein the customized card details comprise a card shape and graphics.

7. The software application of claim 4, wherein the target consumer can further re-use and re-charge the created card for value with the advertiser.

8. The software application of claim 4, wherein the user-interface is further configurable to performing the steps of:
accepting a request from the target consumer to exchange the created card;
publishing the request for another consumer to review;
facilitating an exchange of the created card between the target consumer and the other consumer for value,
wherein the other consumer can use the card for value with the advertiser.

9. A method for providing consolidated card delivery for a plurality of advertisers, the method comprising the steps of:
accepting a first request from a first advertiser to create a first card;
accepting a second request from a second advertiser to create a second card, the first and second advertisers each providing payment and demographic information; the first and second requests comprising card details, positioning selections, target distribution dates, and target consumers for the first and second cards;
creating the first and second cards using a card manufacturer and a graphic designer to conform to the first and second requests;
preparing a publication comprising the created first and second cards when the first and second requests include a similar target distribution date and target consumer, the created first and second cards being removably attached, the created first and second cards being positioned according to the positioning selections from the first and second requests; and
distributing the publication to the target consumer via mail on the target distribution date,
wherein the target consumer can use any of the first and second card for value with the first and second advertiser, respectively.

10. The method of claim 9, wherein the card details comprise technical features, design features, value types, and value amounts.

11. The method of claim 9, wherein the target consumer can further re-use and re-charge the first and second card with the first and second advertiser, respectively.
